(19) United States
(12) Patent Application Publication
(10) Pub. No.: US 2024/0281990 A1
(43) Pub. Date: Aug. 22, 2024

(54) OBJECT COUNT USING MONOCULAR THREE-DIMENSIONAL (3D) PERCEPTION

(71) Applicant: QUALCOMM Incorporated, San Diego, CA (US)

(72) Inventors: Xiaoliang BAI, San Diego, CA (US); Dashan GAO, San Diego, CA (US); Yingyong QI, San Diego, CA (US); Ning BI, San Diego, CA (US)

(21) Appl. No.: 18/172,972

(22) Filed: Feb. 22, 2023

(51) Int. Cl. G06T 7/55

(52) U.S. Cl. CPC G06T 7/55; G06T 2207/10028; G06T 2207/30242

(57) ABSTRACT

Systems and techniques are provided for performing an accurate object count using monocular three-dimensional (3D) perception. In some examples, a computing device can generate a reference depth map based on a reference frame depicting a volume of interest. The computing device can generate a current depth map based on a current frame depicting the volume of interest and one or more objects. The computing device can compare the current depth map to the reference depth map to determine a respective change in depth for each of the one or more objects. The computing device can further compare the respective change in depth for each object to a threshold. The computing device can determine whether each object is located within the volume of interest based on comparing the respective change in depth for each object to the threshold.

### TECHNICAL FIELD

The present disclosure generally relates to image processing. For example, aspects of the present disclosure relate to providing an accurate object count using monocular three-dimensional (3D) perception.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

In some applications, images and/or frames of video may be processed for obtaining an object count. An accurate object count can be important and have many real-life applications. Various different types of objects may be counted including, but not limited to, people, animals, tangible items, and/or electronic devices. Artificial Intelligence (AI) based methods can enhance object counting over traditional methods. However, a false object count may still occur, when in the image, an object appears in a mirror or glass. Furthermore, sometimes it is desirable to only count objects (e.g., a people) that are located within a given 3D volume, such as counting people located within a lounge area waiting for an elevator, but not counting people that are located inside of the elevator itself.

Such an accurate person count requires a 3D scene understanding, especially for verifying whether an object is located inside of the volume of interest. Currently, existing solutions for 3D scene understanding or perception require an additional sensor, such as a stereo camera, light detection and ranging (LIDAR), a time of flight (ToF) sensor, etc. Typically, a 3D model of the environment, which can be expensive to construct, is needed. As such, an improved method for obtaining an accurate object count can be useful.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for an accurate object count using monocular 3D perception. According to at least one illustrative example, a method for processing one or more frames includes: generating a reference depth map based on a reference frame depicting a volume of interest; generating a current depth map based on a current frame depicting the volume of interest and one or more objects; comparing the current depth map to the reference depth map to determine a respective change in depth for each object of the one or more objects; comparing the respective change in depth for each object of the one or more objects to a threshold; and determining whether each object of the one or more objects is located within the volume of interest based on comparing the respective change in depth for each object of the one or more objects to the threshold.

In another illustrative example, an apparatus for processing one or more frames is provided. The apparatus includes at least one memory and at least one processor coupled to the at least one memory and configured to: generate a reference depth map based on a reference frame depicting a volume of interest; generate a current depth map based on a current frame depicting the volume of interest and one or more objects; compare the current depth map to the reference depth map to determine a respective change in depth for each object of the one or more objects; compare the respective change in depth for each object of the one or more objects to a threshold; and determine whether each object of the one or more objects is located within the volume of interest based on comparing the respective change in depth for each object of the one or more objects to the threshold.

In another illustrative example, a non-transitory computer-readable medium is provided that has stored thereon instructions that, when executed by at least one processor, cause the at least one processor to: generate a reference depth map based on a reference frame depicting a volume of interest; generate a current depth map based on a current frame depicting the volume of interest and one or more objects; compare the current depth map to the reference depth map to determine a respective change in depth for each object of the one or more objects; compare the respective change in depth for each object of the one or more objects to a threshold; and determine whether each object of the one or more objects is located within the volume of interest based on comparing the respective change in depth for each object of the one or more objects to the threshold.

In another illustrative example, an apparatus for processing one or more frames is provided. The apparatus includes: means for generating a reference depth map based on a reference frame depicting a volume of interest; means for generating a current depth map based on a current frame depicting the volume of interest and one or more objects; means for comparing the current depth map to the reference depth map to determine a respective change in depth for each object of the one or more objects; means for comparing the respective change in depth for each object of the one or more objects to a threshold; and means for determining whether each object of the one or more objects is located within the volume of interest based on comparing the respective change in depth for each object of the one or more objects to the threshold.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile, device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example image processing system, in accordance with some examples of the present disclosure.

FIG. 2 is a diagram of a frame illustrating an example of a scene with numerous objects (e.g., people), where the objects are located outside of the volume of interest (e.g., an elevator waiting room), in accordance with some examples of the present disclosure.

FIG. 3 is a diagram of a frame illustrating an example of a scene with numerous objects (e.g., people), where the objects are located inside of the volume of interest (e.g., an elevator waiting room), in accordance with some examples of the present disclosure.

FIG. 4 is a diagram illustrating examples of frames and depth maps, in accordance with some examples of the present disclosure.

FIG. 5 is a flowchart showing an example computational flow for an accurate person count, in accordance with some examples of the present disclosure.

FIG. 6 is a flowchart of an example of a process for an accurate object count using monocular 3D perception, in accordance with some examples of the present disclosure.

FIG. 7 illustrates an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

As previously mentioned, computing devices are increasingly being equipped with capabilities for capturing images, performing various image processing tasks, generating various image effects, etc. Images and/or frames of video can be processed for obtaining an object count. An accurate object count can be important and have many real-life applications. Various different types of objects can be counted including, but not limited to, people, animals, tangible items, and/or electronic devices. Artificial Intelligence (AI) based methods can enhance object counting over traditional methods. However, a false object count can still occur (e.g., when in the image, an object appears in a mirror or glass). Furthermore, sometimes it is desirable to only count objects (e.g., people) that are located within a given 3D volume (e.g., such as counting people located within a lounge area waiting for an elevator, but not counting people that are located inside of the elevator itself).

Such an accurate person count may require a 3D scene understanding, such as for verifying whether an object is located inside of the volume of interest. Existing solutions for 3D scene understanding or perception require an additional sensor (e.g., a stereo camera, LIDAR, a ToF sensor, etc.). Generally, a 3D model of the environment, which can be expensive to construct, is needed. As such, there is a need for an improved method for obtaining an accurate object count.

In the following disclosure, systems, apparatuses, methods (also referred to as processes), and computer-readable media (collectively referred to herein as “systems and techniques”) are described herein for providing an accurate object count using monocular 3D perception. In some examples, the systems and techniques described herein can provide a low-cost solution for object counting based on monocular depth estimation. The proposed method can benefit Internet of Things (IoT), safety and security monitoring systems, robotic systems, smart home systems, mapping systems, detection systems, localization systems, entertainment systems, alternative reality (AR), extended reality (XR), virtual reality (VR), and mobile applications. The systems and techniques can be employed for various different scenarios where a volume of interest is utilized.

In one or more aspects, the systems and techniques for providing an accurate object count can utilize a single red, green, blue (RGB) camera, where no other depth sensor is required. The systems and techniques perform an implicit volume of interest computation by using a relative depth change between scenes (e.g., a current frame versus a reference frame). No expensive camera calibration is needed for the systems and techniques and, as such, the systems and techniques can flexibly be adapted for various different scenarios and applications. For the systems and techniques, no 3D reconstruction algorithm and/or implementation is needed, thereby leading to a lower demand on computing resources, which can lead to faster processing speeds and a lower power consumption.

Additional aspects of the present disclosure are described in more detail below.

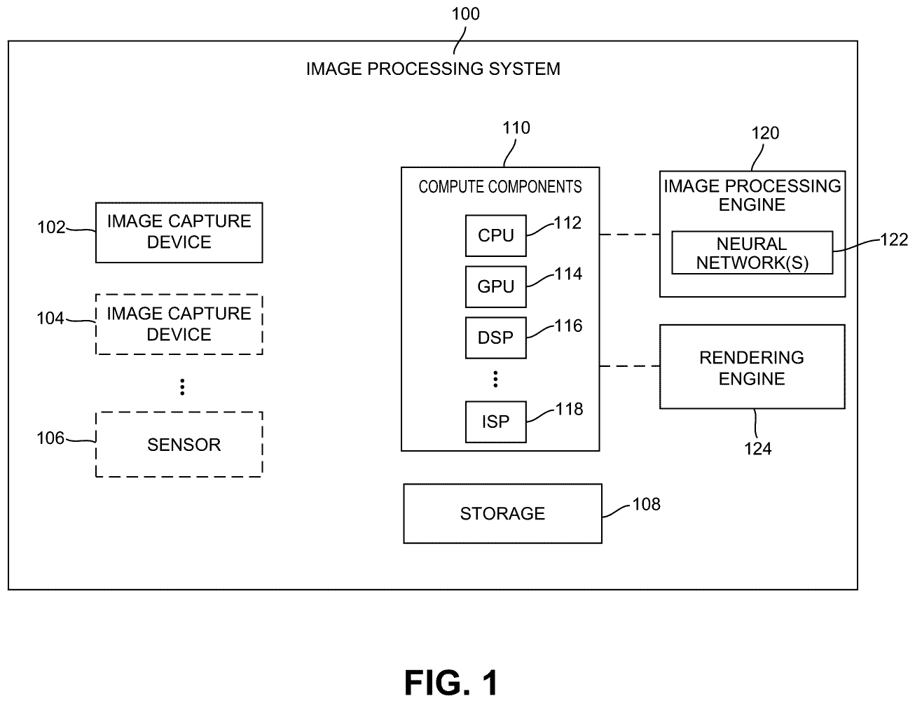

FIG. 1 is a diagram illustrating an example image processing system 100, in accordance with some examples. The image processing system 100 can perform the object counting techniques described herein. Moreover, the image processing system 100 can perform various image processing tasks and generate various image processing effects as described herein. For example, the image processing system 100 can perform an object count, image segmentation, foreground prediction, background replacement, depth-of-field effects, chroma keying effects, feature extraction, object detection, image recognition, machine vision, and/or any other image processing and computer vision tasks.

In the example shown in FIG. 1, the image processing system 100 includes image capture device 102, storage 108, compute components 110, an image processing engine 120, one or more neural network(s) 122, and a rendering engine 124. The image processing system 100 can also optionally include one or more additional image capture devices 104; one or more sensors 106, such as light detection and ranging (LIDAR) sensor, a radio detection and ranging (RADAR) sensor, an accelerometer, a gyroscope, a light sensor, an inertial measurement unit (IMU), a proximity sensor, etc. In some cases, the image processing system 100 can include multiple image capture devices capable of capturing images with different FOVs. For example, in dual camera or image sensor applications, the image processing system 100 can include image capture devices with different types of lenses (e.g., wide angle, telephoto, standard, zoom, etc.) capable of capturing images with different FOVs (e.g., different angles of view, different depths of field, etc.).

The image processing system 100 can be part of a computing device or multiple computing devices. In some examples, the image processing system 100 can be part of an electronic device (or devices) such as a camera system (e.g., a RGB camera, a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a television, a display device, a digital media player, a game console, a video streaming device, a drone, a computer in a car, an IoT (Internet-of-Things) device, a smart wearable device, an extended reality (XR) device (e.g., a head-mounted display, smart glasses, etc.), or any other suitable electronic device(s).

In some implementations, the image capture device 102, the image capture device 104, the other sensor(s) 106, the storage 108, the compute components 110, the image processing engine 120, the neural network(s) 122, and the rendering engine 124 can be part of the same computing device. For example, in some cases, the image capture device 102, the image capture device 104, the other sensor(s) 106, the storage 108, the compute components 110, the image processing engine 120, the neural network(s) 122, and the rendering engine 124 can be integrated into a smartphone, laptop, tablet computer, smart wearable device, game system, XR device, and/or any other computing device. However, in some implementations, the image capture device 102, the image capture device 104, the other sensor(s) 106, the storage 108, the compute components 110, the image processing engine 120, the neural network(s) 122, and/or the rendering engine 124 can be part of two or more separate computing devices.

In some examples, the image capture devices 102 and 104 can be any image and/or video capture devices, such as a digital camera, a video camera, a smartphone camera, a camera device on an electronic apparatus such as a television or computer, a camera system, etc. In some cases, the image capture devices 102 and 104 can be part of a camera or computing device such as a digital camera, a video camera, an IP camera, a smartphone, a smart television, a game system, etc. In some examples, the image capture devices 102 and 104 can be part of a dual-camera assembly. The image capture devices 102 and 104 can capture image and/or video content (e.g., raw image and/or video data), which can then be processed by the compute components 110, the image processing engine 120, the neural network(s) 122, and/or the rendering engine 124 as described herein.

In some cases, the image capture devices 102 and 104 can include image sensors and/or lenses for capturing image data (e.g., still pictures, video frames, etc.). The image capture devices 102 and 104 can capture image data with different or same FOVs, including different or same angles of view, different or same depths of field, different or same sizes, etc. For example, in some cases, the image capture devices 102 and 104 can include different image sensors having different FOVs. In other examples, the image capture devices 102 and 104 can include different types of lenses with different FOVs, such as wide angle lenses, telephoto lenses (e.g., short telephoto, medium telephoto, etc.), standard lenses, zoom lenses, etc. In some examples, the image capture device 102 can include one type of lens and the image capture device 104 can include a different type of lens. In some cases, the image capture devices 102 and 104 can be responsive to different types of light. For example, in some cases, the image capture device 102 can be responsive to visible light and the image capture device 104 can be responsive to infrared light.

The other sensor(s) 106 can be any sensor for detecting and measuring information such as distance, motion, position, depth, speed, etc. Non-limiting examples of sensors include LIDARs, ultrasonic sensors, gyroscopes, accelerometers, magnetometers, RADARs, IMUs, audio sensors, light sensors, etc. In one illustrative example, the sensor 106 can be a LIDAR configured to sense or measure distance and/or depth information which can be used when calculating depth-of-field and other effects. In some cases, the image processing system 100 can include other sensors, such as a machine vision sensor, a smart scene sensor, a speech recognition sensor, an impact sensor, a position sensor, a tilt sensor, a light sensor, etc.

The storage 108 can include any storage device(s) for storing data, such as image data for example. The storage 108 can store data from any of the components of the image processing system 100. For example, the storage 108 can store data or measurements from any of the image capture devices 102 and 104, the other sensor(s) 106, the compute components 110 (e.g., processing parameters, outputs, video, images, segmentation maps, depth maps, filtering results, calculation results, etc.), and/or any of the image processing engine 120, the neural network(s) 122, and/or the rendering engine 124 (e.g., output images, processing results, parameters, etc.). In some examples, the storage 108 can include a buffer for storing data (e.g., image data) for processing by the compute components 110.

In some implementations, the compute components 110 can include a central processing unit (CPU) 112, a graphics processing unit (GPU) 114, a digital signal processor (DSP) 116, and/or an image signal processor (ISP) 118. The compute components 110 can perform various operations such as image enhancement, feature extraction, object or image segmentation, depth estimation, computer vision, graphics rendering, XR (e.g., augmented reality, virtual reality, mixed reality, and the like), image/video processing, sensor processing, recognition (e.g., text recognition, object recognition, feature recognition, facial recognition, pattern recognition, scene recognition, etc.), foreground prediction, machine learning, filtering, depth-of-field effect calculations or renderings, tracking, localization, and/or any of the various operations described herein. In some examples, the compute components 110 can implement the image processing engine 120, the neural network(s) 122, and the rendering engine 124. In other examples, the compute components 110 can also implement one or more other processing engines.

The operations of the image processing engine 120, the neural network(s) 122, and the rendering engine 124 can be implemented by one or more of the compute components 110. In one illustrative example, the image processing engine 120 and the neural network(s) 122 (and associated operations) can be implemented by the CPU 112, the DSP 116, and/or the ISP 118, and the rendering engine 124 (and associated operations) can be implemented by the GPU 114. In some cases, the compute components 110 can include other electronic circuits or hardware, computer software, firmware, or any combination thereof, to perform any of the various operations described herein.

In some cases, the compute components 110 can receive data (e.g., image data, etc.) captured by the image capture device 102 and/or the image capture device 104, and process the data to generate output images or videos having certain visual and/or image processing effects such as, for example, depth-of-field effects, background replacement, tracking, object detection, etc. For example, the compute components 110 can receive image data (e.g., one or more still images or video frames, etc.) captured by the image capture devices 102 and 104, perform depth estimation, image segmentation, and depth filtering, and generate an output segmentation result as described herein. An image (or frame) can be a RGB image having red, green, and blue color components per pixel; a luma, chroma-red, chroma-blue (YCbCr) image having a luma component and two chroma (color) components (chroma-red and chroma-blue) per pixel; or any other suitable type of color or monochrome picture.

The compute components 110 can implement the image processing engine 120 and the neural network(s) 122 to perform various image processing operations and generate image effects. For example, the compute components 110 can implement the image processing engine 120 and the neural network(s) 122 to perform feature extraction, superpixel detection, foreground prediction, spatial mapping, saliency detection, segmentation, depth estimation, depth filtering, pixel classification, cropping, upsampling/downsampling, blurring, modeling, filtering, color correction, noise reduction, scaling, ranking, adaptive Gaussian thresholding and/or other image processing tasks. The compute components 110 can process image data captured by the image capture device 102 and/or 104; image data in storage 108; image data received from a remote source, such as a remote camera, a server or a content provider; image data obtained from a combination of sources; etc.

In some examples, the compute components 110 can generate a depth map from a monocular image captured by the image capture device 102, generate a segmentation map from the monocular image, generate a refined or updated segmentation map based on a depth filtering performed by comparing the depth map and the segmentation map to filter pixels/regions having at least a threshold depth, and generate a segmentation output. In some cases, the compute components 110 can use spatial information (e.g., a center prior map), probability maps, disparity information (e.g., a disparity map), image queries, saliency maps, etc., to segment objects and/or regions in one or more images and generate an output image with an image effect, such as a depth-of-field effect. In other cases, the compute components 110 can also use other information such as face detection information, sensor measurements (e.g., depth measurements), depth measurements, etc.

In some examples, the compute components 110 can perform segmentation (e.g., foreground-background segmentation, object segmentation, etc.) at (or nearly at) pixel-level or region-level accuracy. In some cases, the compute components 110 can perform segmentation using images with different FOVs. For example, the compute components 110 can perform segmentation using an image with a first FOV captured by image capture device 102, and an image with a second FOV captured by image capture device 104. The segmentation can also enable (or can be used in conjunction with) other image adjustments or image processing operations such as, for example and without limitation, depth-enhanced and object-aware auto exposure, auto white balance, auto-focus, tone mapping, etc.

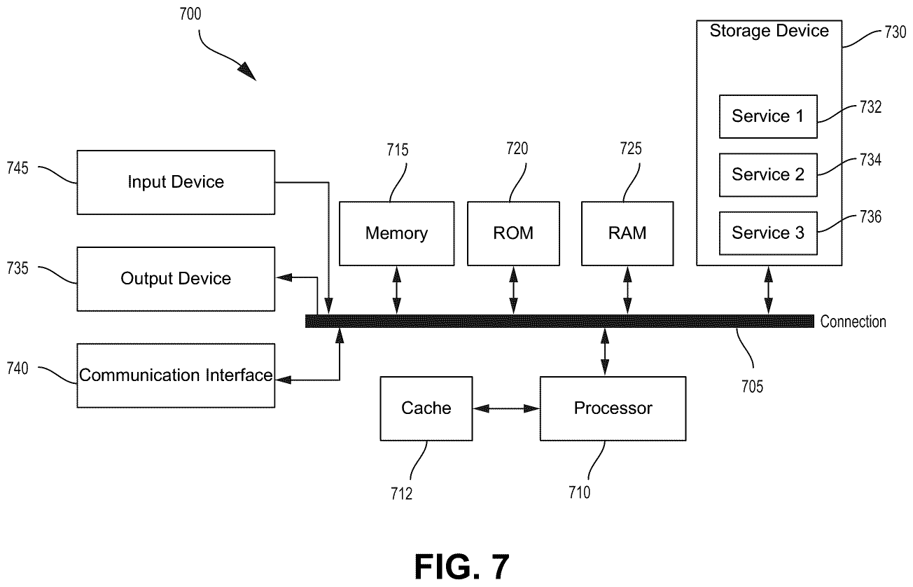

While the image processing system 100 is shown to include certain components, one of ordinary skill will appreciate that the image processing system 100 can include more or fewer components than those shown in FIG. 1. For example, the image processing system 100 can also include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the image processing system 100 is described below with respect to FIG. 7.

As previously mentioned, computing devices are increasingly being equipped with capabilities for capturing images, performing various image processing tasks, generating various image effects, etc. Images and/or frames of video may be processed for obtaining an object count. An accurate object count can be important and can have many real-life applications. Different types of objects can be counted including, but not limited to, people, animals, tangible items, and/or electronic devices. AI based methods can be used to enhance object counting over traditional methods. A false object count, however, may still occur (e.g., when in the image, an object appears in a mirror or glass).

In one or more examples, it can be desirable to count objects (e.g., people) that are located within a given 3D volume. For example, for an elevator scenario, such as for a smart elevator, it may be desirable to count people located within a lounge area waiting for the elevator, but not count people that are located inside of the elevator itself. For another example, for a video game console, such as an XR or AR device, it may be desirable to count people located within a volume of interest (e.g., a particular area zoned for the gaming experience), while not including in the count people located outside of the volume of interest, to provide a better user gaming experience. In other examples, it may be desirable to count people in other various different scenarios where a volume of interest is required.

An accurate person count requires a 3D scene understanding, especially for verifying whether an object is located inside of a volume of interest. Currently, existing solutions for 3D scene understanding or perception require using an additional sensor (e.g., a stereo camera, LIDAR, a ToF sensor, etc.). Generally, a 3D model of the environment is needed. The existing solutions determine coordinates related to the boundaries of the 3D model of the environment (e.g., which models the volume of interest) and coordinates for objects located with the environment, and perform a comparison (e.g., determine the distances of the objects with respect to the volume of interest) to determine whether the objects are located within the volume of interest. Constructing an accurate 3D model of the environment can be expensive and can require calibration of equipment.

The systems and techniques provide for an accurate object count using monocular 3D perception (e.g., based on monocular depth estimation). In one or more aspects, the systems and techniques may employ a single RGB camera for providing an accurate object count (e.g., no other depth sensor is needed). The systems and techniques perform an implicit volume of interest computation by using a relative depth change between scenes (e.g., a current frame compared with a reference frame). The systems and techniques do not require camera calibration and, as such, the systems and techniques may easily be adapted for various different scenarios and applications. No 3D reconstruction algorithm and/or implementation is needed for the systems and techniques, and this may result in leading to a lower demand on computing resources, which can allow for faster processing speeds and a lower power consumption.

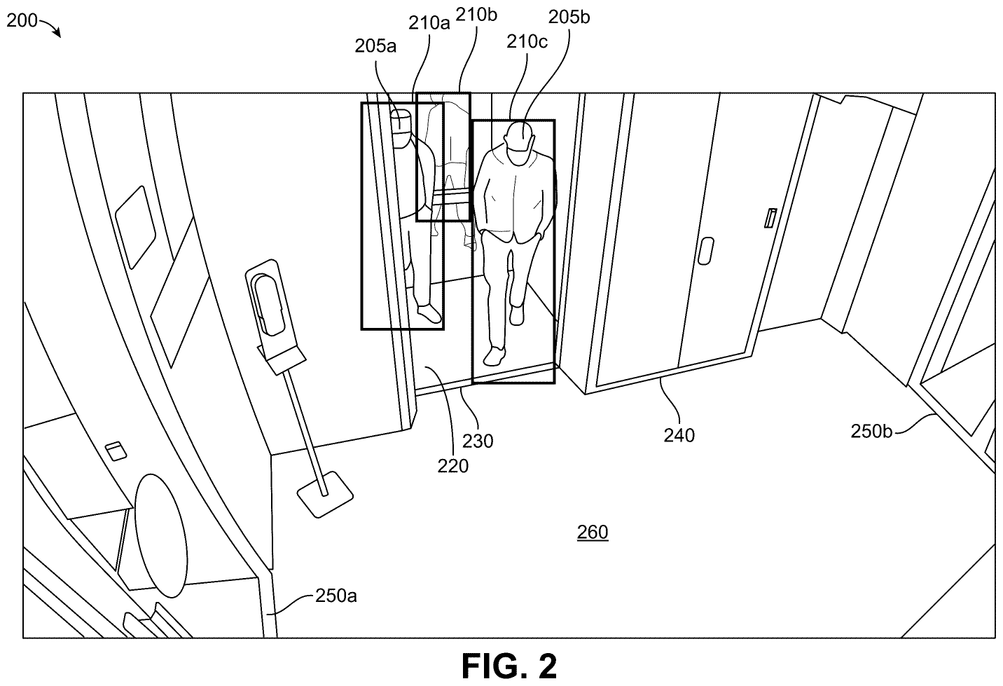

FIG. 2 shows an example of a frame (e.g., a still image or a frame from a video) of a scene 200. In particular, FIG. 2 is a diagram of a frame illustrating an example of a scene 200 containing numerous objects (e.g., people, such as person A 205a and person B 205b), where objects (e.g., people, such as person A 205a and person B 205b) are located outside of the volume of interest (e.g., a lounge area 260, which can be utilized as an elevator waiting room). In one or more examples, the frame of FIG. 2 can be a RGB image having red, green, and blue color components per pixel.

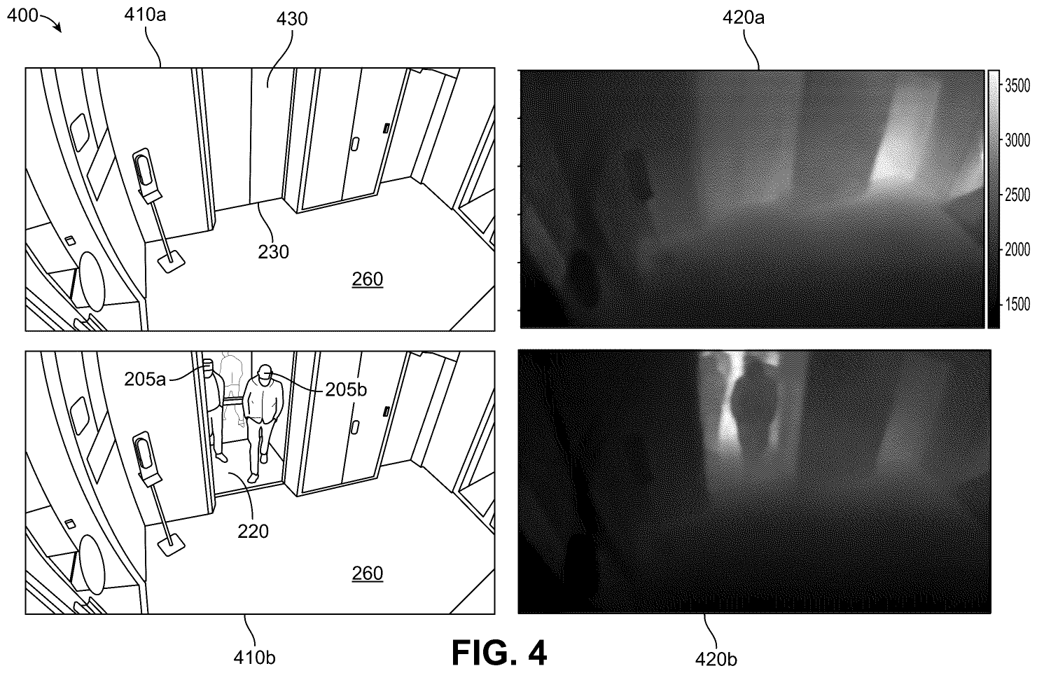

The scene 200 of FIG. 2 shows an elevator scenario, where the elevator 220 may or may not be a smart elevator. In FIG. 2, the frame (e.g., captured from a still image or a frame of a video) showing the scene 200 may be captured by a security camera located within the lounge area 260. In one or more examples, the security camera can be a RGB camera. The lounge area 260 can be used by people to wait for the elevator 220. The lounge area 260, in the scene 200, is bordered by a wall 240, two glass doors 250a, 250b, and the elevator door (e.g., shown as elevator door 430 of FIG. 4) of the elevator 220. The two glass doors 250a, 250b, in the scene 200, are shown to be located on opposite sides of the lounge area 260 from each other.

In the scene 200, the elevator door (e.g., shown as elevator door 430 of FIG. 4) of the elevator 220 is shown to be open, and the elevator door threshold 230 is visible in the scene 200. Also shown in the scene 200 are two people (e.g., person A 205a and person B 205b). Both of the people (e.g., person A 205a and person B 205b) are shown to be located inside of the elevator 220 such that neither of the people (e.g., neither person A 205a nor person B 205b) are crossing the elevator door threshold 230 into the lounge area 260.

In one or more examples, such as for a smart elevator scenario, it may be desirable to count the number of people located within the lounge area 260 waiting for the elevator 220, but not count the number of people located within the elevator 220 itself. A volume of interest (e.g., a defined 3D space) and a target of interest (e.g., people) need to be identified for the count. For these examples, the lounge area 260 can be identified to be the volume of interest, and people (e.g., person A 205a and person B 205b) can be identified to be the target of interest for performing the count. In one or more examples, the image processing system 100 may perform the count. Objects (e.g., people) that are located within the volume of interest (e.g., the lounge area 260) may be included within the count. Objects (e.g., people) and other objects (e.g., objects other than people) that are not located within the volume of interest (e.g., the lounge area 260) may not be included within the count. Other objects (e.g., objects that are not people) that are located within the volume of interest (e.g., the lounge area 260) also may not be included within the count.

In some examples, the image processing system 100 may detect people (e.g., person A 205a and person B 205b) in the scene 200 of the frame. As shown in FIG. 2, the image processing system can generate bounding boxes 210a, 210b, 210c (e.g., which may be segmentation masks) to indicate the detections of people in the scene 200 of the frame. For example, bounding box 210a in the scene 200 can be indicative of the detection of person A 205a, and bounding box 210c in the scene 200 can be indicative of the detection of person B 205b. However, bounding box 210b is the result of a false detection a person because bounding box 210b has resulted from the detection of a reflection in a mirror (e.g., located on the back side of the elevator 220) of person B 205b.

In the scene 200 of FIG. 2, none of the detected people (e.g., person A 205a and person B 205b) in the bounding boxes 210a, 210c (or the falsely detected person in the bounding box 210b) are shown to be crossing the elevator threshold 230 to enter the lounge area 230 (e.g., the volume of interest). As such, none of the detected people (e.g., person A 205a and person B 205b) (or the falsely detected person in the bounding box 210b) are considered to be located within the volume of interest (e.g., the lounge area 260). Since none of the detected people (e.g., person A 205a and person B 205b) (or the falsely detected person in the bounding box 210b) are considered to be located within the volume of interest (e.g., the lounge area 230), the bounding boxes 210a, 210b, 210c are depicted to be formed with solid bold lines.

Since none of the detected people (e.g., person A 205a and person B 205b) (or the falsely detected person in the bounding box 210b) are considered to be located within the volume of interest (e.g., the lounge area 230), none of the detected people (e.g., person A 205a and person B 205b) (or the falsely detected person in the bounding box 210b) may be included within the count. As such, for the scene 200 of the frame, the image processing system 100 may count zero objects (e.g., people) located within the volume of interest (e.g., lounge area 260).

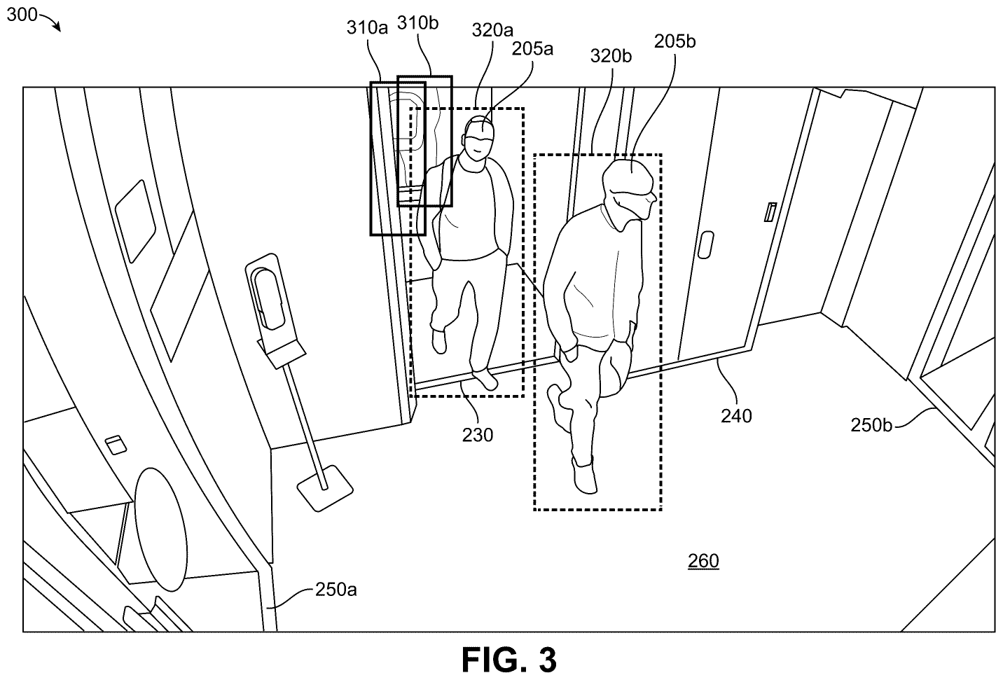

FIG. 3 shows an example of frame (e.g., a still image or a frame from a video) of a scene 300, including the lounge area 260, captured by a camera a short time after the capturing of the frame of the scene 200 of FIG. 2. In particular, FIG. 3 is a diagram of a frame illustrating an example of a scene 300 with numerous objects (e.g., people, such as person A 205a and person B 205b), where the objects (e.g., people, such as person A 205a and person B 205b) are located inside of the volume of interest (e.g., the lounge area 260). In one or more examples, the frame of FIG. 3 can be a RGB image having red, green, and blue color components per pixel.

In the scene 300 of FIG. 3, the frame (e.g., captured from a still image or a frame of a video) showing the scene 300 may be captured by a security camera that is located within the lounge area 260. The frame showing the scene 300 may be captured by the security camera a short time after the frame showing the scene 200 is captured by the security camera. The security camera may be a RGB camera.

In some examples, the image processing system 100 may detect the people (e.g., person A 205a and person B 205b) in the scene 300 of the frame. As shown in FIG. 3, the image processing system can generate bounding boxes 310a, 310b, 320a, 320b (e.g., which may be segmentation masks) to indicate the detections of people in the scene 300 of the frame. For example, bounding box 320a in the scene 300 can be indicative of the detection of person A 205a, and bounding box 320b in the scene 300 can be indicative of the detection of person B 205b. Bounding boxes 310a, 310b are the result of false detections of people because bounding box 310a has resulted from the detection of a reflection in a mirror (e.g., located on the back side of the elevator 220) of person A 205a and bounding box 310b has resulted from the detection of a reflection in a mirror (e.g., located on the back side of the elevator 220) of person B 205b.

In the scene 300 of FIG. 3, the elevator door (e.g., shown as elevator door 430 of FIG. 4) of the elevator 220 is shown to be open. One person (e.g., person B 205b) in bounding box 320b is shown to be located completely outside of the elevator 220 and completely inside of the lounge area 260 (e.g., the volume of interest). Since this person (e.g., person B 205b) is shown to be located completely outside of the elevator 220 and completely inside of the lounge area 260, this person (e.g., person B 205b) is considered to be located within the volume of interest (e.g., the lounge area 260), and the bounding box 320b is depicted to be formed with a dashed bold line.

The other person (e.g., person A 205a) in bounding box 320a is shown in the scene 300 to be crossing (e.g., with his foot) the elevator threshold 230 entering into the lounge area 260. Since this person (e.g., person A 205a) is shown to be at least partially located within the lounge area 260 (e.g., the area of interest), this person (e.g., person A 205a) is considered to be located within the volume of interest (e.g., the lounge area 260), and the bounding box 320a is depicted to be formed with a dashed bold line.

The falsely detected people indicated by bounding boxes 310a, 310b are shown to be located inside of the elevator 220. Since the falsely detected people in bounding boxes 310a, 310b are not at least partially located within the lounge area 260 (e.g., the volume of interest), the falsely detected people in bounding boxes 310a, 310b are not considered to be located within the volume of interest (e.g., the lounge area 260), and the bounding boxes 310a, 310b are depicted to be formed with solid bold lines.

Since the detected people (e.g., person A 205a and person B 205b) are considered to be located within the volume of interest (e.g., the lounge area 230), the detected people (e.g., person A 205a and person B 205b) may be included within the count. Since the falsely detected people in bounding boxes 310a, 310b are not considered to be located within the volume of interest (e.g., the lounge area 260), the falsely detected people in bounding boxes 310a, 310b may not be included within the count. As such, for the scene 300 of the frame, the image processing system 100 may count two objects (e.g., people, person A 205a and person B 205b) located within the volume of interest (e.g., the lounge area 260).

As noted above, some existing solutions (e.g., AI based methods or traditional methods) for counting objects (e.g., people) within a volume of interest may erroneously include in their count of objects falsely detected objects (e.g., reflections of objects, such as people, in a mirror of glass). The systems and techniques provide a solution for counting objects within a volume of interest that can distinguish real objects from falsely detected objects (e.g., reflections of objects) by using monocular depth estimation. In one or more aspects, the systems and techniques utilize a single RGB camera to provide the depth estimation. The systems and techniques can perform an implicit volume of interest calculation using relative depth change between scenes (e.g., between a current frame versus a reference frame). By examining the relative depth change in two-dimensional region of interest (e.g., a bounding box of an object or a segmentation mask for an object), the systems and techniques can determine whether an object (e.g., person) is located inside of the volume of interest or outside of the volume of interest.

FIG. 4 shows examples of frames and associated depth maps that may be used for counting objects (e.g., people) using monocular depth based on an implicit volume of interest (e.g., a lounge area 260 for an elevator 220). In particular, FIG. 4 is a diagram 400 illustrating examples of frames (e.g., a reference frame 410a and a current frame 410b) and depth maps (e.g., a reference depth map 420a and a current depth map 420b).

In FIG. 4, the reference frame 410a is a frame (e.g., a still image or a frame from video) that can be captured by a camera, such as an RGB camera, at a first time (e.g., a reference time). The reference frame 410a can be used by the image processing system 100 to determine (e.g., to define) the volume of interest (e.g., which may be the lounge area 260). In the reference frame 410a, the elevator doors 420 of the elevator 220 are shown to be shut and, as such, the volume of interest may be determined to be (e.g., defined to be) the lounge area 260 (e.g., the 3D space of the lounge area 260), which is bordered by the elevator threshold 230 of the elevator 220.

The image processing system 100 may process (e.g., by using the image processing engine 120 of the image processing system 100) the reference frame 410a to generate a reference depth map 420a (e.g., a monocular depth map). The reference depth map 420a shows a mapping of depths that correspond to objects within the scene in the reference frame 410a.

Also in FIG. 4, a current frame 410b is a frame (e.g., a still image or a frame from video) that can be captured by a camera, such as an RGB camera, at a second time (e.g., a current time), which is after the first time (e.g., the reference time). The current frame 410b may be used by the image processing system 100 to determine a count of objects (e.g., people) located within the determined (e.g., defined) volume of interest (e.g., which may be the lounge area 260). In the current frame 410b, the elevator doors are open, and two people (e.g., person A 205a and person B 205b) are shown to be located inside of the elevator and not located within the lounge area 260 (e.g., the volume of interest). Since the people (e.g., person A 205a and person B 205b) are not located within the volume of interest (e.g., the lounge area 260), the people should not be counted.

The image processing system 100 can process (e.g., by using the image processing engine 120 of the image processing system 100) the current frame 410b to generate a current depth map 420b (e.g., a monocular depth map). The current depth map 420b shows a mapping of depths that correspond to objects within the scene in the reference frame 410b.

After the image processing system 100 has generated the reference depth map 420a and the current depth map 420b, the image processing system 100 can use the monocular depths in the reference depth map 420a and the current depth map 420b to compute (e.g., calculate) the depth changes from the reference depth map 420a and the current depth map 420b. The image processing system 100 can determine the depth changes from the reference depth map 420a and the current depth map 420b by subtracting the depths of the objects in the current depth map 420b from the depths of the objects in the reference depth map 420a. The image processing system 100 can then use the determined depth changes in the targets of interest (e.g., indicated by bounding boxes or segmentation masks for the objects) to determine whether the objects (e.g., people) are located within the volume of interest (e.g., lounge area 260). When the image processing system 100 determines that the targets of interest (e.g., indicated by bounding boxes or segmentation masks for the objects) are located within the volume of interest (e.g., lounge area 260), the image processing system 100 can include the objects (e.g., people) associated with the targets of interest in the count. However, when the image processing system 100 determines that the targets of interest (e.g., indicated by bounding boxes or segmentation masks for the objects) are not located within the volume of interest (e.g., lounge area 260), the image processing system 100 may not include the objects (e.g., people) associated with the targets of interest in the count.

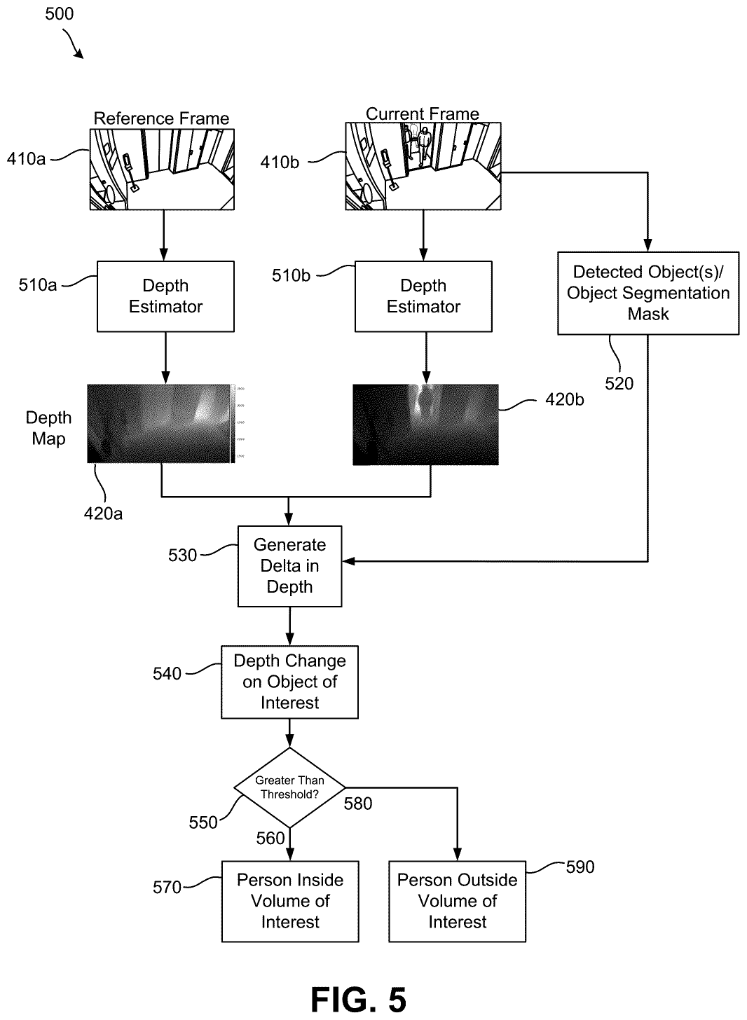

FIG. 5 shows an example of a process that may be employed (e.g., by the image processing system 100) for counting objects (e.g., targets of interest, such as people) within a volume of interest (e.g., a lounge area 260). In particular, FIG. 5 is a flowchart showing an example computational flow 500 for an accurate person count. In FIG. 5, a reference frame 410a (e.g., a still image or a frame from video) including a scene (e.g., a reference scene) can be captured by a camera, such as an RGB camera, at a first time (e.g., a reference time). The scene (e.g., reference scene) of the reference frame 410a may not include any targets of interest (e.g., objects, such as a people). The reference frame 410a can be preprocessed (e.g., by the image processing system 100) during a system setup stage.

The image processing system 100 can process (e.g., by using the image processing engine 120 of the image processing system 100) the reference frame 410a to generate a reference depth map 420a (e.g., a monocular depth map). In one or more examples, the image processing system 100 can use a depth estimator 510a to generate the reference depth map 420a. The depth estimator 510a can be or can implement a machine learning model (e.g., a deep neural network trained using deep learning training based on monocular depth) to generate the reference depth map 420a. In one or more examples, for the deep learning training, the depth estimator 510a may use self-supervised, semi-self-supervised, and/or fully-supervised training. The generated reference depth map 420a shows a mapping of depths that correspond to objects within the scene in the reference frame 410a.

Then, at a second time (e.g., a current time), which is at a later time than the first time (e.g., the reference time), a current frame 410b (e.g., a still image or a frame from video) including a scene (e.g., a current scene) can be captured by a camera, such as an RGB camera. The image processing system 100 can process (e.g., by using the image processing engine 120 of the image processing system 100) in real time the current frame 410b to generate a current depth map 420b (e.g., a monocular depth map). In some examples, the image processing system 100 can use a depth estimator 510b to generate the current depth map 420a. The depth estimator 510b can be or can implement a machine learning model (e.g., a deep neural network trained using deep learning training based on monocular depth, such as self-supervised, semi-self-supervised, and/or fully-supervised training) to generate the current depth map 420b. The current reference depth map 420b shows a mapping of depths that correspond to objects within the scene in the current frame 410b.

After the current frame 410b (e.g., a still image or a frame from video) is captured by a camera, the image processing system 100 may process the current frame 410b to detect objects 520 (e.g., people) within the scene of the current frame 410b. After the image processing system 100 has detected objects 520 (e.g., people) within the scene, the image processing system 100 can generate bounding boxes (e.g., which may be object segmentation masks) 520 that surround the detected objects (e.g., people) to indicate the detections of the objects (e.g., people) in the scene of the current frame 410b. For example, one bounding box in the scene of the current frame 410b can be generated to indicate the detection of a first person (e.g., person A), and a second bounding box in the scene of the current frame 410b can generated to indicate of the detection of a second person (e.g., person B).

Based on the generated bounding boxes (e.g., or segmentation masks), the image processing system 100 can generate 530 (e.g., determine and/or calculate) the relative change in depth 540 (e.g., delta in depth) of the detected objects (e.g., surrounded by the bounding boxes or segmentation masks) to determine whether an object (e.g., person) appears (e.g., is located) within or is outside of the volume of interest (e.g., the lounge area 260). In one or more examples, the relative change in depth 540 (e.g., delta in depth) of the detected objects (e.g., surrounded by the bounding boxes or segmentation masks) can be determined by comparing the depths of the reference depth map 420a to the current depth map 420b on a per pixel basis.

After the image processing system 100 has determined the change in depth 540 (e.g., delta in depth), the image processing system 100 can compare the change in depth 540 (e.g., delta in depth) for each detected object to a threshold 550 (e.g., which may be a predetermined threshold, such as a value in distance in meters) to determine whether or not the detected object is located within the volume of interest (e.g., lounge area 260). When the image processing system 100 determines that the change in depth 540 (e.g., delta in depth) for a detected object is greater than 560 the threshold 550, the image processing system 100 can determine that the detected object (e.g., person) is located 570 within the volume of interest (e.g., lounge area 260). Conversely, when the image processing system 100 determines that the change in depth 540 (e.g., delta in depth) for a detected object is less than 580 the threshold 550, the image processing system 100 can determine that the detected object (e.g., person) is not located 590 within the volume of interest (e.g., lounge area 260). Then, the image processing system 100 may count the number of detected objects (e.g., people) that are determined to be located 570 within the volume of interest (e.g., lounge area 260) for the object count.

In one or more examples, to address a change in the environment (e.g., lighting condition, new furniture, etc.) of the scene, the reference frame 410a may be updated, when no target of interest (e.g., object, such as a person) appears.

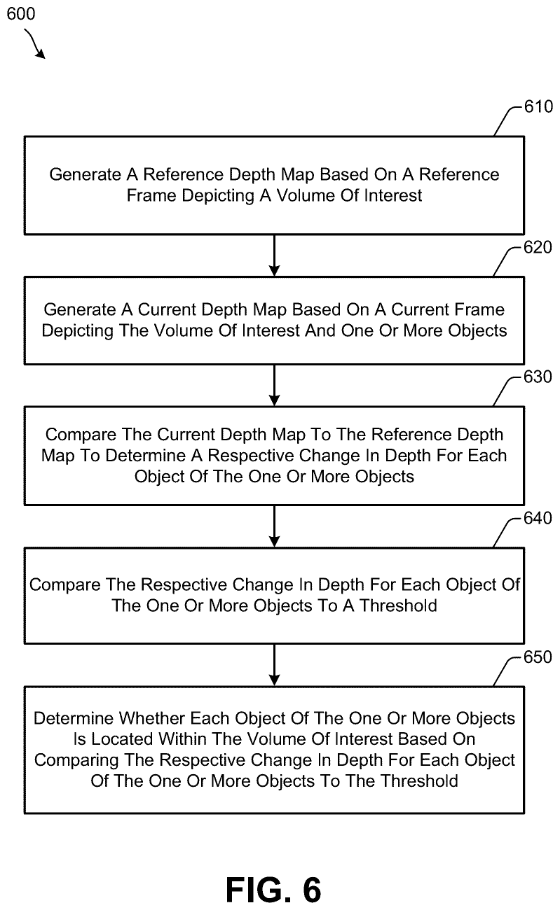

FIG. 6 is a flow chart illustrating an example of a process 600 for an accurate object count using monocular 3D perception. The process 600 can be performed by a computing device (or system), or by a component or system (e.g., a chipset) of the computing device or system. In one illustrative example, the process 600 can be performed by the image processing system 100 of FIG. 1. The operations of the process 600 may be implemented as software components that are executed and run on one or more processors (e.g., one or more of the compute components 110 of FIG. 1, the image processing engine 120 of FIG. 1, the rendering engine 124 of FIG. 1, the processor 710 of FIG. 7, any combination thereof, and/or other processor(s)).

At block 610, the computing device (or component thereof) can generate a reference depth map (e.g., reference depth map 420a of FIG. 4) based on a reference frame (e.g., reference frame 410a of FIG. 4) depicting a volume of interest (e.g., the lounge area 260 of FIG. 2-FIG. 4). At block 620, the computing device (or component thereof) can generate a current depth map (e.g., current depth map 420b of FIG. 4) based on a current frame (e.g., current frame 410b of FIG. 4) depicting the volume of interest and one or more objects. In some cases, the one or more objects include a person (e.g., person A 205a and person B 205b of FIG. 2-FIG. 4), an animal, a tangible good, electronic device, any combination thereof, and/or other objects. In some aspects, the computing device (or component thereof) can obtain the reference frame capturing a reference scene (e.g., the scene depicted in the reference frame 410a of FIG. 4) including the volume of interest and can obtain the current frame capturing a current scene (e.g., the scene depicted in the current frame 410b of FIG. 4) including the volume of interest and the one or more objects. For instance, the computing device (or component thereof) can obtain the reference frame and the current frame from a camera. In some examples, the reference frame is a monocular frame captured by a monocular camera device (e.g., image capture device 102). Additionally or alternatively, in some examples, the current frame is a monocular frame captured by a monocular camera device (e.g., image capture device 102). In some cases, the reference frame and the current frame are each one of an image or a frame of a video.

In some aspects, the computing device (or component thereof) can generate the reference depth map and the current depth map using a machine learning model (e.g., a neural network or other type of machine learning model). In some cases, the machine learning model is trained using self-supervised training, semi-self-supervised training, fully-supervised training, any combination thereof, and/or other training process.

In some aspects, the computing device (or component thereof) can detect the one or more objects (e.g., detected object/object segmentation mask 520 of FIG. 5) in the current frame. In some cases, the computing device (or component thereof) can generate a respective bounding box for each object of the one or more objects based on detecting the one or more objects. In some examples, the computing device (or component thereof) can generate a segmentation mask (e.g., detected object/object segmentation mask 520) for the one or more objects based on performing instance segmentation on the current frame.

At block 630, the computing device (or component thereof) can compare the current depth map to the reference depth map to determine a respective change in depth for each object of the one or more objects. For example, as described with respect to the computational flow 500 of FIG. 5, the computing device can compare the depths of the reference depth map 420a to the current depth map 420b (e.g., on a per pixel basis) to determine the relative change in depth 540 (e.g., delta in depth) of the detected objects (e.g., surrounded by bounding boxes or segmentation masks).

At block 640, the computing device (or component thereof) can compare the respective change in depth for each object of the one or more objects to a threshold. For example, as described with respect to the computational flow 500 of FIG. 5, the computing device can compare the change in depth 540 (e.g., delta in depth) for each detected object to a threshold 550 (e.g., a predetermined threshold, such as a value in distance in meters).

At block 650, the computing device (or component thereof) can determine whether each object of the one or more objects is located within the volume of interest based on comparing the respective change in depth for each object of the one or more objects to the threshold. For example, as described with respect to the computational flow 500 of FIG. 5, the computing device can compare the change in depth 540 for each detected object to the threshold 550 to determine whether or not the detected object is located within the volume of interest (e.g., lounge area 260). In some aspects, the computing device (or component thereof) can count at least one object (e.g., targets of interest, such as people) of the one or more objects that is located within the volume of interest. For instance, as described with respect to FIG. 4 and FIG. 5, the computing device (or component thereof) can determine that one or more targets of interest (e.g., indicated by bounding boxes or segmentation masks for the objects) are located within the volume of interest (e.g., lounge area 260 of FIG. 2-FIG. 4), in which case the computing device (or component thereof) can include the objects (e.g., people) associated with the targets of interest in the count. However, if the computing device (or component thereof) determines that the targets of interest (e.g., indicated by bounding boxes or segmentation masks for the objects) are not located within the volume of interest (e.g., lounge area 260), the computing device (or component thereof) may not include the objects (e.g., people) associated with the targets of interest in the count.

In some examples, the process 600 may be performed by one or more computing devices or apparatuses. In one illustrative example, the process 600 can be performed by the image processing system 100 shown in FIG. 1 and/or one or more computing devices with the computing device architecture 700 shown in FIG. 7. In some cases, such a computing device or apparatus may include a processor, microprocessor, microcomputer, or other component of a device that is configured to carry out the steps of the process 600. In some examples, such computing device or apparatus may include one or more sensors configured to capture image data. For example, the computing device can include a smartphone, a head-mounted display, a mobile device, a camera, a tablet computer, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 7 illustrates an example computing device architecture 700 of an example computing device which can implement various techniques described herein. For example, the computing device architecture 700 can implement at least some portions of the image processing system 100 shown in FIG. 1. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics.

The processor 710 can include any general purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device. In some instances, multimodal computing devices can enable a user to provide multiple types of input to communicate with the computing device architecture 700. The communication interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. A method for processing one or more frames, the method comprising: generating a reference depth map based on a reference frame depicting a volume of interest; generating a current depth map based on a current frame depicting the volume of interest and one or more objects; comparing the current depth map to the reference depth map to determine a respective change in depth for each object of the one or more objects; comparing the respective change in depth for each object of the one or more objects to a threshold; and determining whether each object of the one or more objects is located within the volume of interest based on comparing the respective change in depth for each object of the one or more objects to the threshold.
Aspect 2. The method of Aspect 1, further comprising: obtaining the reference frame capturing a reference scene comprising the volume of interest; and obtaining the current frame capturing a current scene comprising the volume of interest and the one or more objects.
Aspect 3. The method of Aspect 2, wherein obtaining the reference frame and obtaining the current frame are performed using a camera.
Aspect 4. The method of any one of Aspects 1 to 3, wherein the reference frame and the current frame are each one of an image or a frame of a video.
Aspect 5. The method of any one of Aspects 1 to 4, further comprising detecting the one or more objects in the current frame.
Aspect 6. The method of Aspect 5, further comprising generating a respective bounding box for each object of the one or more objects based on detecting the one or more objects.
Aspect 7. The method of any one of Aspects 1 to 6, further comprising generating a segmentation mask for the one or more objects based on performing instance segmentation on the current frame.
Aspect 8. The method of any one of Aspects 1 to 7, further comprising counting at least one object of the one or more objects that is located within the volume of interest.
Aspect 9. The method of any one of Aspects 1 to 8, wherein the one or more objects include at least one of a person, an animal, a tangible good, or an electronic device.
Aspect 10. The method of any one of Aspects 1 to 9, wherein the reference depth map and the current depth map are generated using a machine learning model.
Aspect 11. The method of Aspect 10, wherein the machine learning model is trained using at least one of self-supervised, semi-self-supervised, or fully-supervised training.
Aspect 12. An apparatus for processing one or more frames, the apparatus comprising: at least one memory; and at least one processor coupled to the at least one memory and configured to: generate a reference depth map based on a reference frame depicting a volume of interest; generate a current depth map based on a current frame depicting the volume of interest and one or more objects; compare the current depth map to the reference depth map to determine a respective change in depth for each object of the one or more objects; compare the respective change in depth for each object of the one or more objects to a threshold; and determine whether each object of the one or more objects is located within the volume of interest based on comparing the respective change in depth for each object of the one or more objects to the threshold.
Aspect 13. The apparatus of Aspect 12, wherein the at least one processor is configured to: obtain the reference frame capturing a reference scene comprising the volume of interest; and obtain the current frame capturing a current scene comprising the volume of interest and the one or more objects.
Aspect 14. The apparatus of Aspect 13, wherein the at least one processor is configured to obtain the reference frame and the current frame from a camera.
Aspect 15. The apparatus of any one of Aspects 12 to 14, wherein the reference frame and the current frame are each one of an image or a frame of a video.
Aspect 16. The apparatus of any one of Aspects 12 to 15, wherein the at least one processor is configured to detect the one or more objects in the current frame.
Aspect 17. The apparatus of Aspect 16, wherein the at least one processor is configured to generate a respective bounding box for each object of the one or more objects based on detecting the one or more objects.
Aspect 18. The apparatus of any one of Aspects 12 to 17, wherein the at least one processor is configured to generate a segmentation mask for the one or more objects based on performing instance segmentation on the current frame.
Aspect 19. The apparatus of any one of Aspects 12 to 18, wherein the at least one processor is configured to count at least one object of the one or more objects that is located within the volume of interest.
Aspect 20. The apparatus of any one of Aspects 12 to 19, wherein the one or more objects include at least one of a person, an animal, a tangible good, or an electronic device.
Aspect 21. The apparatus of any one of Aspects 12 to 20, wherein the at least one processor is configured to generate the reference depth map and the current depth map using a machine learning model.
Aspect 22. The apparatus of Aspect 21, wherein the machine learning model is trained using at least one of self-supervised, semi-self-supervised, or fully-supervised training.
Aspect 23. A non-transitory computer-readable medium having stored thereon instructions that, when executed by at least one processor, cause the at least one processor to perform operation according to any of Aspects 1 to 11.
Aspect 24. An apparatus for wireless communications, comprising one or more means for performing operations according to any of Aspects 1 to 11.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for processing one or more frames, the method comprising:
generating a reference depth map based on a reference frame depicting a volume of interest;
generating a current depth map based on a current frame depicting the volume of interest and one or more objects;
comparing the current depth map to the reference depth map to determine a respective change in depth for each object of the one or more objects;
comparing the respective change in depth for each object of the one or more objects to a threshold; and
determining whether each object of the one or more objects is located within the volume of interest based on comparing the respective change in depth for each object of the one or more objects to the threshold.

2. The method of claim 1, further comprising:
obtaining the reference frame capturing a reference scene comprising the volume of interest; and
obtaining the current frame capturing a current scene comprising the volume of interest and the one or more objects.

3. The method of claim 2, wherein obtaining the reference frame and obtaining the current frame are performed using a camera.

4. The method of claim 1, wherein the reference frame and the current frame are each one of an image or a frame of a video.

5. The method of claim 1, further comprising detecting the one or more objects in the current frame.

6. The method of claim 5, further comprising generating a respective bounding box for each object of the one or more objects based on detecting the one or more objects.

7. The method of claim 1, further comprising generating a segmentation mask for the one or more objects based on performing instance segmentation on the current frame.

8. The method of claim 1, further comprising counting at least one object of the one or more objects that is located within the volume of interest.

9. The method of claim 1, wherein the one or more objects include at least one of a person, an animal, a tangible good, or an electronic device.

10. The method of claim 1, wherein the reference depth map and the current depth map are generated using a machine learning model.

11. The method of claim 10, wherein the machine learning model is trained using at least one of self-supervised, semi-self-supervised, or fully-supervised training.

12. An apparatus for processing one or more frames, the apparatus comprising:
at least one memory; and
at least one processor coupled to the at least one memory and configured to:
generate a reference depth map based on a reference frame depicting a volume of interest;
generate a current depth map based on a current frame depicting the volume of interest and one or more objects;
compare the current depth map to the reference depth map to determine a respective change in depth for each object of the one or more objects;
compare the respective change in depth for each object of the one or more objects to a threshold; and
determine whether each object of the one or more objects is located within the volume of interest based on comparing the respective change in depth for each object of the one or more objects to the threshold.

13. The apparatus of claim 12, wherein the at least one processor is configured to:
obtain the reference frame capturing a reference scene comprising the volume of interest; and
obtain the current frame capturing a current scene comprising the volume of interest and the one or more objects.

14. The apparatus of claim 13, wherein the at least one processor is configured to obtain the reference frame and the current frame from a camera.

15. The apparatus of claim 12, wherein the reference frame and the current frame are each one of an image or a frame of a video.

16. The apparatus of claim 12, wherein the at least one processor is configured to detect the one or more objects in the current frame.

17. The apparatus of claim 16, wherein the at least one processor is configured to generate a respective bounding box for each object of the one or more objects based on detecting the one or more objects.

18. The apparatus of claim 12, wherein the at least one processor is configured to generate a segmentation mask for the one or more objects based on performing instance segmentation on the current frame.

19. The apparatus of claim 12, wherein the at least one processor is configured to count at least one object of the one or more objects that is located within the volume of interest.

20. The apparatus of claim 12, wherein the one or more objects include at least one of a person, an animal, a tangible good, or an electronic device.

21. The apparatus of claim 12, wherein the at least one processor is configured to generate the reference depth map and the current depth map using a machine learning model.

22. The apparatus of claim 21, wherein the machine learning model is trained using at least one of self-supervised, semi-self-supervised, or fully-supervised training.

23. A non-transitory computer-readable medium having stored thereon instructions that, when executed by at least one processor, cause the at least one processor to:
generate a reference depth map based on a reference frame depicting a volume of interest;
generate a current depth map based on a current frame depicting the volume of interest and one or more objects;
compare the current depth map to the reference depth map to determine a respective change in depth for each object of the one or more objects;
compare the respective change in depth for each object of the one or more objects to a threshold; and
determine whether each object of the one or more objects is located within the volume of interest based on comparing the respective change in depth for each object of the one or more objects to the threshold.

24. The non-transitory computer-readable medium of claim 23, wherein the instructions, when executed by the at least one processor, cause the at least one processor to:
obtain the reference frame capturing a reference scene comprising the volume of interest; and
obtain the current frame capturing a current scene comprising the volume of interest and the one or more objects.

25. The non-transitory computer-readable medium of claim 23, wherein the instructions, when executed by the at least one processor, cause the at least one processor to detect the one or more objects in the current frame.

26. The non-transitory computer-readable medium of claim 25, wherein the instructions, when executed by the at least one processor, cause the at least one processor to generate a respective bounding box for each object of the one or more objects based on detecting the one or more objects.

27. The non-transitory computer-readable medium of claim 23, wherein the instructions, when executed by the at least one processor, cause the at least one processor to generate a segmentation mask for the one or more objects based on performing instance segmentation on the current frame.

28. The non-transitory computer-readable medium of claim 23, wherein the instructions, when executed by the at least one processor, cause the at least one processor to count at least one object of the one or more objects that is located within the volume of interest.

29. The non-transitory computer-readable medium of claim 23, wherein the instructions, when executed by the at least one processor, cause the at least one processor to generate the reference depth map and the current depth map using a machine learning model.

30. The non-transitory computer-readable medium of claim 29, wherein the machine learning model is trained using at least one of self-supervised, semi-self-supervised, or fully-supervised training.
